(19) United States
(12) Patent Application Publication
(10) Pub. No.: US 2026/0095971 A1
(43) Pub. Date: Apr. 2, 2026

(54) METHODS FOR MOBILE TERMINATING DATA/SIGNALING HANDLING FOR UES IN RRC INACTIVE STATE, NETWORK NODE AND RADIO NETWORK NODE

(71) Applicant: TELEFONAKTIEBOLAGET LM ERICSSON (PUBL), Stockholm (SE)

(72) Inventors: Qian CHEN, Molndal (SE); Paul SCHLIWA-BERTLING, Ljungsbro (SE); Mohammed Yazid LYAZIDI, London (GB)

(21) Appl. No.: 19/103,926

(22) PCT Filed: Aug. 14, 2023
(86) PCT No.: PCT/IB2023/058185

§ 371 Date: Feb. 14, 2025

Related U.S. Application Data
(60) Provisional application No. 63/398,317, filed on Aug. 16, 2022.

(51) Int. Cl. H04W 76/27; H04W 76/28

(52) U.S. Cl. CPC H04W 76/27; H04W 76/28

(57) ABSTRACT

Method and apparatus are provided for a network function in a core network (CN) and a Radio Access network (RAN) node in the RAN, where the network function in the CN determines a capability of the CN to support handling of Mobile Terminated (MT) data/signalling for a User Equipment (UE) (e.g., buffering) when in Radio Resource Control (RRC) INACTIVE state with long extended Discontinuous Reception (eDRX) cycle (e.g., more than 10.24 s) and transmitting to the RAN node serving the UE an indication indicating support of the CN for MT data/signalling handling. Based on the received indication, the RAN node determines that MT data/signalling can be handled (e.g., buffered) in the CN for the UE in RRC_INACTIVE state with long eDRX cycle.

### RELATED APPLICATIONS

This application claims the benefit of provisional patent application Ser. No. 63/398,317, filed on Aug. 16, 2022, the disclosure of which is hereby incorporated herein by reference in its entirety.

### TECHNICAL FIELD

The present disclosure relates to the operation of a Radio Access Network and a Core Network for a wireless device in an RRC inactive state with long eDRX cycle.

### BACKGROUND

The 3GPP Rel-18 SA2 study item, FS_RedCap_Ph2, is to address the support of long eDRX (>10.24 s) value in RRC_INACTIVE state. The key issue is how to handle Mobile Terminating (MT) data/signalling when a User Equipment (UE) (aka wireless device) is unreachable due to long eDRX in RRC_INACTIVE state as stated in 3GPP TR 23.700-68 V.1.0.0, herein cited by reference.

Two types of solutions are documented in the TR referred to as type A) and type B).

Type A: CN based) The NG-RAN in the 5G system provides UE unreachability information (e.g. the eDRX information) to the Core Network (CN) when UE enters RRC_INACTIVE state with long eDRX and the CN handles the MT data/signalling while the UE is unreachable. Using existing CN data buffering capability and existing MT data/signalling handling in the CN, the CN triggers MT data/signalling when the UE is considered reachable, i.e., when the UE becomes reachable, the CN triggers the NG-RAN paging even if the N3 connection exists. For example, see solution 6.1, 6.3, 6.4 and 6.6 in TR 23.700-68 for reference. Solution 6.6 is a converged solution based on Solutions 6.1, 6.3 and 6.4.

Type B: NG-RAN based) The NG-RAN handles MT data/signalling while the UE is RRC_INACTIVE state. In case the UE moves out of the RAN based Notification area (RNA) during the unreachable time period and performs a resume outside the RNA, the UE context retrieval between NG-RAN nodes and data forwarding are supported via the CN when there is no Xn interface between the NG-RAN nodes. See for example solutions 6.2, 6.2a in 3GPP TR 23.700-68 for reference.

Hence, in type A, CN handles MT data/signalling when UE is unreachable; and in type B) RAN handles MT data/signalling when UE is unreachable.

These two different types of solution are applicable for different scenarios/use cases.

### SUMMARY

Systems, methods and apparatus for handling selection or determining the type of solution to apply for handling MT data/signalling for UEs in RRC inactive state are provided. In some embodiments, the NG-RAN, more specifically the gNB determines whether the CN handles MT data/signalling for UEs entering RRC inactive state with long eDRX cycle (Type A) or whether the RAN should handle the MT data/signalling for UE entering RRC inactive state with long eDRX cycle (Type B). The determination by the NG-RAN is based on the knowledge of the capability of the Core Network (CN) to support handling MT data/signalling. Optionally the NG-RAN node may in addition consider other policies in selecting whether type A, type B or both should be applied.

In some embodiments, a method performed by a network function such as an Access and Mobility management Function (AMF) in a core network (CN) such as 5G Core network. The method comprising determining by the network function a capability of the CN to support handling of Mobile Terminated (MT) data/signalling for a User Equipment (UE) when in Radio Resource Control (RRC) INACTIVE state with long extended Discontinuous Reception (eDRX) cycle (e.g., more than 10.24 s), such as buffering of MT data/signalling. The method further comprises transmitting by the network function to the Radio Access Network (RAN) serving the UE (e.g., gNB in a 5G system) an indication indicating support of the CN for MT data/signalling handling.

The indication may be transmitted to the Radio Access Network (RAN) in an INITIAL CONTEXT SETUP REQUEST message, a UE CONTEXT MODIFICATION REQUEST message, a HANDOVER REQUEST message, a PATH SWITCH REQUEST ACKNOWLEDGE message, a NG/N2 SETUP RESPONSE message, a AMF CONFIGURATION UPDATE message.

In one embodiment, the indication is transmitted to the RAN in a CN Assistance Information for RRC INACTIVE Information Element included in any of the N2 message (indicated above).

In some embodiments, a method performed by a radio network node in a Radio Access Network (RAN) (e.g., a gNB in 5G system) and connected to a Core network (CN) is provided. The method comprises receiving by the radio network node from the CN an indication indicating the CN support for MT data/signalling handling (e.g., buffering) for a User Equipment (UE) to be used for the UE when in Radio Resource Control (RRC) INACTIVE state with long extended Discontinuous Reception (eDRX) cycle (e.g., more than 10.24 s), and based on the received indication, determining that MT data/signalling can be handled in the CN for the UE in RRC_INACTIVE state with long eDRX cycle.

The indication may be transmitted received from the CN in a CN Assistance Information for RRC INACTIVE Information Element or a separate Information element that may be included in an INITIAL CONTEXT SETUP REQUEST message, a UE CONTEXT MODIFICATION REQUEST message, a HANDOVER REQUEST message, a PATH SWITCH REQUEST ACKNOWLEDGE message, a NG/N2 SETUP RESPONSE message and an AMF CONFIGURATION UPDATE message.

The indication may further indicate that the CN does not support handling Mobile Terminated (MT) data/signalling in which case the radio network node may determine whether to handle MT data/signalling at the radio network node.

According to some embodiments, a network node implementing a network function in a Core Network (CN) is provided, the network node comprising processing circuitry and memory comprising instructions which when executed by the processing circuitry performs any of the method embodiments described herein.

According to some embodiments, a radio network node is provided, the radio network node comprising processing circuitry and memory comprising instructions which when executed by the processing circuitry performs any of the method embodiments described herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system 300 in which embodiments of the present disclosure may be implemented;

FIG. 2 illustrates a wireless communication system represented as a 5G network architecture composed of core Network Functions (NFs), where interaction between any two NFs is represented by a point-to-point reference point/interface;

FIG. 3 illustrates a 5G network architecture using service-based interfaces between the NFs in the control plane, instead of the point-to-point reference points/interfaces used in the 5G network architecture of FIG. 4;

FIG. 4 illustrates a method in a network function (e.g., AMF) of the CN according to some embodiments of the present disclosure;

FIG. 5 illustrates a method in a radio network node (e.g., gNB) of the Radio Access Network according to some embodiments of the present disclosure;

FIGS. 6 and 7 illustrates embodiments of a Radio Access Node, according to some embodiments of the present disclosure;

FIG. 8 is a schematic block diagram illustrating a virtualization environment in which functions implemented by some embodiments may be virtualized, according to some embodiments of the present disclosure;

FIG. 9, 10 illustrates exemplary embodiments of a wireless device/UE, according to some embodiments of the present disclosure;

FIG. 11 illustrates an example of a communication system implementing the embodiments of the present disclosure;

FIG. 12 illustrates example implementations, in accordance with an embodiment, of the UE, base station, and host computer of FIG. 13, according to some embodiments of the present disclosure;

FIGS. 13 through 16 are flow charts illustrating methods implemented in a communication system, according to some embodiments of the present disclosure; and

### ADDITIONAL DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node. Future 6G radio access nodes and beyond are also included for this invention.

Core Network Node: As used herein, a “core network node” is any type of node, including a server or a data center, in a core network that implements a core network function. Some examples of a 4G (EPC) core network function implemented on a node include, e.g., a Mobility Management Entity (MME), a Packet Data Network Gateway (PGW), a Service Capability Exposure Function (SCEF), a Home Subscriber Server (HSS), or the like. Examples of 5G core network function include an Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like. The Core network functions may be virtualized/containerized on a node (e.g., server, distributed servers) or implemented on-premise using a dedicated physical node (compute, memory, and network). Other future core network functions in future core networks such as 6G and beyond are also applicable for this invention.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams. Further note that the description herein is based on 5G Core network, however the invention can be applied between any core network and a radio access network node, such as an EPC and an LTE eNB.

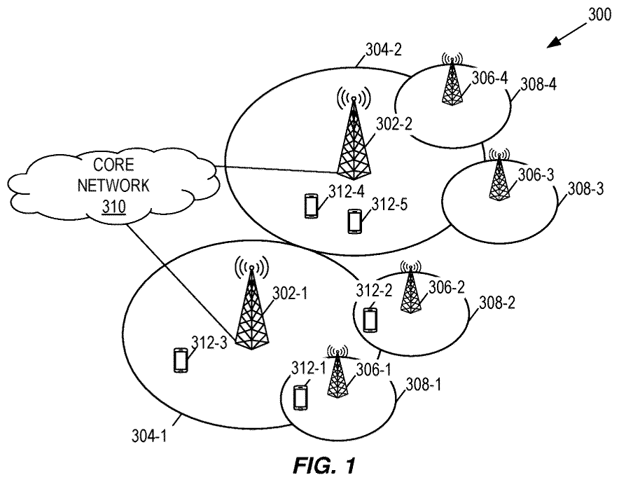

FIG. 1 illustrates one example of a cellular communications system 300 in which embodiments of the present disclosure may be implemented. In the embodiments described herein, the cellular communications system 300 may be a 5G system (5GS) including a NR RAN, an Evolved Packet System (EPS) including an LTE RAN, or a RAN that includes both 5GS and EPS components. In this example, the RAN includes base stations or NG-RAN nodes 302-1 and 302-2, which in LTE are referred to as eNBs and in 5G NR are referred to as gNBs, controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5GS is referred to as the 5G core (5GC). The base stations 302 (and optionally the low power nodes 306) are connected to the core network 310.

The base stations 302 and the low power nodes 306 provide service to wireless devices 312-1 through 312-5 in the corresponding cells 304 and 308. The wireless devices 312-1 through 312-5 are generally referred to herein collectively as wireless devices 312 and individually as wireless device 312. The wireless devices 312 are also sometimes referred to herein as UEs.

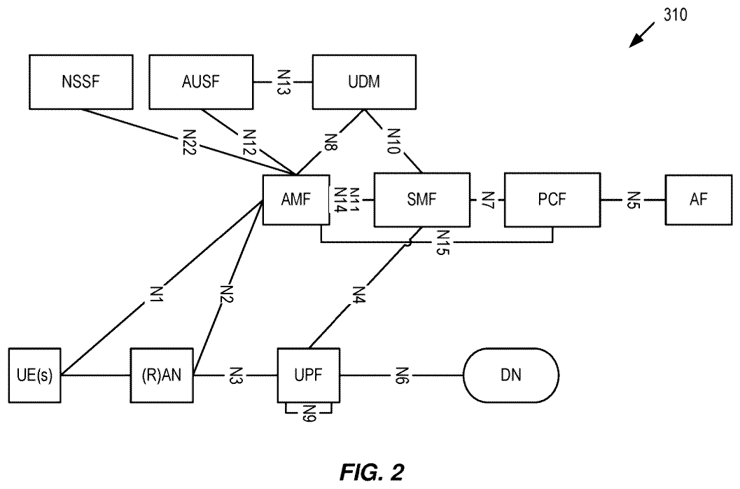

FIG. 2 illustrates a wireless communication system represented as a 5G network architecture composed of core Network Functions (NFs), where interaction between any two NFs is represented by a point-to-point reference point/interface. FIG. 2 can be viewed as one particular implementation of the system 300 of FIG. 1.

Seen from the access side the 5G network architecture shown in FIG. 2 comprises a plurality of User Equipment (UEs) connected to either a Radio Access Network (RAN) as well as an Access and Mobility Management Function (AMF). Typically, the (R)AN in FIG. 2 is also referred to as NG-RAN in this description and comprises base stations, e.g. such as evolved Node Bs (eNBs) or 5G base stations (gNBs) or similar. Seen from the core network side, the 5G core NFs shown in FIG. 2 include a Network Slice Selection Function (NSSF), an Authentication Server Function (AUSF), a Unified Data Management (UDM), an AMF, a Session Management Function (SMF), a Policy Control Function (PCF), and a User Plane Function (UPF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMF, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 2, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

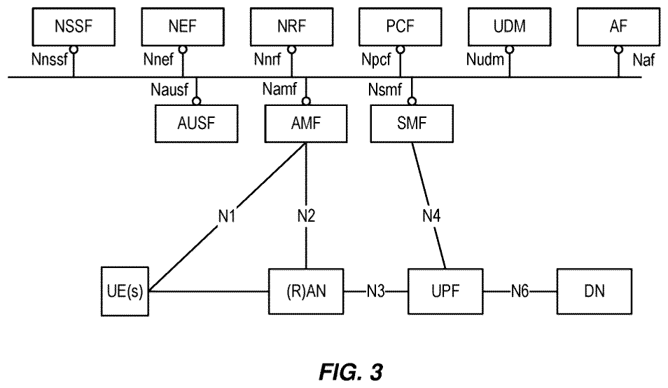

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g., Namf for the service based interface of the AMF and Nsmf for the service based interface of the SMF etc. The Network Exposure Function (NEF) and the Network Function (NF) Repository Function (NRF) in FIG. 3 are not shown in FIG. 2 discussed above. However, it should be clarified that all NFs depicted in FIG. 2 can interact with the NEF and the NRF of FIG. 2 as necessary, though not explicitly indicated in FIG. 2.

Some properties of the NFs shown in FIGS. 2 and 3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Currently the AMF provides to the NG-RAN node assistance information to assist the NG-RAN's decision whether the UE can be sent to RRC Inactive state. The “RRC Inactive Assistance Information” as described in 3GPP TS 23.501 includes:
UE specific DRX values;
UE specific extended idle mode DRX values (cycle length and Paging Time Window length);
The Registration Area provided to the UE;
Periodic Registration Update timer;
If the AMF has enabled MICO mode for the UE, an indication that the UE is in MICO mode;
Information from the UE identifier that allows the RAN to calculate the UE's RAN paging occasions;
An indication that Paging Cause Indication for Voice Service is supported;
AMF Paging Early Indication with Paging Subgrouping (PEIPS) Assistance Information for paging a UE in CM-CONNECTED with RRC Inactive state over.

The RRC Inactive Assistance Information mentioned above is provided by the AMF during N2 activation with the (new) serving NG-RAN node (i.e. during Registration, Service Request, Handover) to assist the NG RAN's decision whether the UE can be sent to RRC Inactive state.

RRC Inactive state is part of RRC state machine, and it is up to the RAN to determine the conditions to enter RRC Inactive state. If any of the parameters included in the RRC Inactive Assistance Information changes as the result of NAS procedure, the AMF shall update the RRC Inactive Assistance Information to the NG-RAN node.

When the UE is in CM-CONNECTED state, if the AMF has provided RRC Inactive assistance information, the RAN node may decide to move a UE to CM-CONNECTED with RRC Inactive state.

The 5G Core network is not aware of the UE transitions between CM-CONNECTED with RRC Connected and CM-CONNECTED with RRC Inactive state, unless the 5G Core network is notified via N2 notification procedure.
At transition into CM-CONNECTED with RRC Inactive state, the NG-RAN configures the UE with a periodic RAN Notification Area Update timer taking into account the value of the Periodic Registration Update timer value indicated in the RRC Inactive Assistance Information, and uses a guard timer with a value longer than the RAN Notification Area Update timer value provided to the UE.
If the periodic RAN Notification Area Update guard timer expires in NG-RAN, the NG-RAN shall initiate AN Release procedure.
When the UE is in CM-CONNECTED with RRC Inactive state, the UE performs PLMN selection procedures.
When the UE is CM-CONNECTED with RRC Inactive state, the UE may resume the RRC Connection due to:
Uplink data pending;
Mobile initiated NAS signalling procedure;
As a response to RAN paging;
Notifying the network that it has left the RAN Notification Area;
Upon periodic RAN Notification Area Update timer expiration.

To support RRC INACTIVE state with extended DRX cycle longer than 10.24 s, embodiments are presented to enable the NG-RAN node to select type A) and/or type B) solution (above) for handling MT data/signalling for UE with long eDRX cycle in RRC INACTIVE when UE is unreachable. Both type A) and type B) solution need functionality from the CN side (AMF). When NG-RAN makes the decision on the selection of type A) or type B) approach, it's critical for the NG-RAN to know the CN capability, especially in the case of multi-vendors cases. Otherwise, coexistence of the two solutions cannot work.

To support the NG-RAN in its decision, the CN (e.g., AMF in 5G or MME in 4G) provides buffering support parameter to the NG-RAN. The NG-RAN uses this information, and optionally together with other input parameters, to decide if the CN MT data/signalling handling or RAN MT data/signalling handling shall be used for UE in long eDRX with RRC_INACTIVE state.

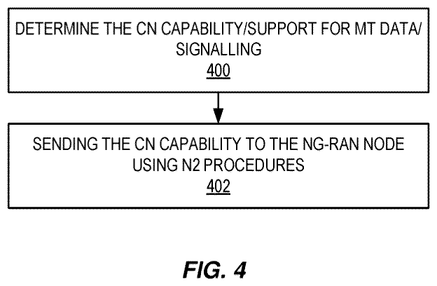

FIG. 4 illustrates a method performed by the CN function (e.g., AMF) for enabling the NG-RAN to decide if the CN MT data/signalling handling or RAN MT data/signalling handling shall be used for UE in long eDRX with RRC_INACTIVE state.

The CN function (E.g., AMF) after determining the CN capability/support for MT data/signalling handling (step 400), it provides the CN capability/support indication parameter related to MT data/signalling handling to the NG-RAN by sending (step 402) to the NG-RAN node during one or more N2 procedure (using UE specific or non UE specific N2 signalling messages). The AMF may transmit the CN capability indication in any of the following N2 procedures and messages:

### Initial UE Context Setup

According to the embodiment, when the AMF sends NGAP Initial Context Setup Request message to the NG-RAN, it can include the MT data/signalling handling capability parameter as part of the “Core Network Assistance Information for RRC_INACTIVE” Information Element (IE) (shown underlined below) or as a separate IE (e.g., CN MT data/signalling support indication IE shown underlined below). The details of the modified Initial UE Context Setup message described in 3GPP TS 38.413 is illustrated below (changes are shown underlined):

### Initial Context Setup Request

This message is sent by the AMF to request the setup of a UE context.
Direction: AMF→NG-RAN node

| | | | IE type and | Semantics | | Assigned |
|---|---|---|---|---|---|---|
| IE/Group Name | Presence | Range | reference | description | Criticality | Criticality |
| Message Type | M | | 9.3.1.1 of TS 38.413 | | YES | reject |
| AMF UE NGAP ID | M | | 9.3.3.1 | | YES | reject |
| RAN UE NGAP ID | M | | 9.3.3.2 | | YES | reject |
| Old AMF | O | | AMF Name | | YES | reject |
| | | | 9.3.3.21 | | | |
| UE Aggregate | C- | | 9.3.1.58 | | YES | reject |
| Maximum Bit Rate | ifPDUsessionRe- | | | | | |
| | sourceSetup | | | | | |
| Core Network | O | | 9.3.1.15 | | YES | ignore |
| Assistance | | | | | | |
| Information for RRC | | | | | | |
| INACTIVE | | | | | | |
| GUAMI | M | | 9.3.3.3 | | YES | reject |
| PDU Session | | 0 . . . 1 | | | YES | reject |
| Resource Setup | | | | | | |
| Request List | | | | | | |
| >PDU Session | | 1 . . . | | | — | |
| Resource Setup | | <maxnoofPDUSessions> | | | | |
| Request Item | | | | | | |
| >>PDU Session ID | M | | 9.3.1.50 | | — | |
| >>PDU Session | O | | NAS-PDU | | — | |
| NAS-PDU | | | 9.3.3.4 | | | |
| >>S-NSSAI | M | | 9.3.1.24 | | — | |
| >>PDU Session | M | | OCTET STRING | Containing | — | |
| Resource Setup | | | | the PDU | | |
| Request Transfer | | | | Session | | |
| | | | | Resource | | |
| | | | | Setup | | |
| | | | | Request | | |
| | | | | Transfer IE | | |
| | | | | specified in | | |
| | | | | subclause | | |
| | | | | 9.3.4.1. | | |
| >>PDU Session | O | | Expected UE | Expected UE | YES | ignore |
| Expected UE Activity | | | Activity Behaviour | Activity | | |
| Behaviour | | | 9.3.1.94 | Behaviour for | | |
| | | | | the PDU | | |
| | | | | Session. | | |
| Allowed NSSAI | M | | 9.3.1.31 | Indicates the | YES | reject |
| | | | | S-NSSAIs | | |
| | | | | permitted by | | |
| | | | | the network | | |
| UE Security | M | | 9.3.1.86 | | YES | reject |
| Capabilities | | | | | | |
| Security Key | M | | 9.3.1.87 | | YES | reject |
| Trace Activation | O | | 9.3.1.14 | | YES | ignore |
| Mobility Restriction List | O | | 9.3.1.85 | | YES | ignore |
| UE Radio Capability | O | | 9.3.1.74 | | YES | ignore |
| Index to | O | | 9.3.1.61 | | YES | ignore |
| RAT/Frequency | | | | | | |
| Selection Priority | | | | | | |
| Masked IMEISV | O | | 9.3.1.54 | | YES | ignore |
| NAS-PDU | O | | 9.3.3.4 | | YES | ignore |
| Emergency Fallback | O | | 9.3.1.26 | | YES | reject |
| Indicator | | | | | | |
| RRC Inactive | O | | 9.3.1.91 | | YES | ignore |
| Transition Report | | | | | | |
| Request | | | | | | |
| UE Radio Capability | O | | 9.3.1.68 | | YES | ignore |
| for Paging | | | | | | |
| Redirection for Voice | O | | 9.3.1.116 | | YES | ignore |
| EPS Fallback | | | | | | |
| Location Reporting | O | | 9.3.1.65 | | YES | ignore |
| Request Type | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| IAB Authorized | O | | 9.3.1.129 | | YES | ignore |
| Enhanced Coverage | O | | 9.3.1.140 | | YES | ignore |
| Restriction | | | | | | |
| Extended Connected | O | | 9.3.3.31 | | YES | ignore |
| Time | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE | YES | ignore |
| Aggregate Maximum | | | | applies only if | | |
| Bit Rate | | | | the UE is | | |
| | | | | authorized for | | |
| | | | | NR V2X | | |
| | | | | services. | | |
| LTE UE Sidelink | O | | 9.3.1.149 | This IE | YES | ignore |
| Aggregate Maximum | | | | applies only if | | |
| Bit Rate | | | | the UE is | | |
| | | | | authorized for | | |
| | | | | LTE V2X | | |
| | | | | services. | | |
| PC5 QoS Parameters | O | | 9.3.1.150 | This IE | YES | ignore |
| | | | | applies only if | | |
| | | | | the UE is | | |
| | | | | authorized for | | |
| | | | | NR V2X | | |
| | | | | services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| RG Level Wireline | O | | OCTET STRING | Specified in | YES | ignore |
| Access Characteristics | | | | TS 23.316 | | |
| | | | | [34]. | | |
| | | | | Indicates the | | |
| | | | | wireline | | |
| | | | | access | | |
| | | | | technology | | |
| | | | | specific QoS | | |
| | | | | information | | |
| | | | | corresponding | | |
| | | | | to a specific | | |
| | | | | wireline | | |
| | | | | access | | |
| | | | | subscription. | | |
| Management Based | O | | MDT PLMN List | | YES | ignore |
| MDT PLMN List | | | 9.3.1.168 | | | |
| UE Radio Capability ID | O | | 9.3.1.142 | | YES | reject |
| Time Synchronisation | O | | 9.3.1.220 | | YES | ignore |
| Assistance Information | | | | | | |
| QMC Configuration | O | | 9.3.1.223 | | YES | ignore |
| Information | | | | | | |
| Target NSSAI | O | | 9.3.1.229 | | YES | ignore |
| Information | | | | | | |
| UE Slice Maximum Bit | O | | 9.3.1.231 | | YES | ignore |
| Rate List | | | | | | |
| 5G ProSe Authorized | O | | 9.3.1.233 | | YES | ignore |
| 5G ProSe UE PC5 | O | | NR UE Sidelink Aggregate | This IE | YES | ignore |
| Aggregate Maximum | | | Maximum Bit Rate | applies only if | | |
| Bit Rate | | | 9.3.1.148 | the UE is | | |
| | | | | authorized for | | |
| | | | | 5G ProSe | | |
| | | | | services. | | |
| 5G ProSe PC5 QoS | O | | 9.3.1.234 | This IE | YES | ignore |
| Parameters | | | | applies only if | | |
| | | | | the UE is | | |
| | | | | authorized for | | |
| | | | | 5G ProSe | | |
| | | | | services. | | |
| CN MT data/ | O | | ENUMERATED | This IE | YES | ignore |
| signalling | | | (CN, RAN, | indicates the | | |
| support indication | | | Both, none . . . ) | 5GC support | | |
| | | | | capabilities | | |
| | | | | for MT data/ | | |
| | | | | signalling | | |
| | | | | handling in | | |
| | | | | CN, MT data/ | | |
| | | | | signalling | | |
| | | | | handling in | | |
| | | | | RAN, or both. | | |

| | Explanation |
|---|---|
| Range bound | |
| maxnoofPDUSessions | Maximum no. of PDU sessions allowed |
| | towards one UE. Value is 256. |
| Condition | |
| ifPDUsessionResourceSetup | This IE shall be present if the PDU |
| | Session Resource Setup List IE is present. |

If the CN capability indication for MT data/signalling is included as part of the CN assistance information for RRC Inactive IE, the indication may be included as follows:
Modified Core Network Assistance Information for RRC INACTIVE
This IE provides assistance information for RRC_INACTIVE configuration.

| | | | IE type and | Semantics | | Assigned |
|---|---|---|---|---|---|---|
| IE/Group Name | Presence | Range | reference | description | Criticality | Criticality |
| UE Identity Index | M | | 9.3.3.23 | | — | |
| Value | | | | | | |
| UE Specific DRX | O | | Paging DRX | | — | |
| | | | 9.3.1.90 | | | |
| Periodic Registration | M | | 9.3.3.24 | | — | |
| Update Timer | | | | | | |
| MICO Mode Indication | O | | 9.3.1.23 | | — | |
| TAI List for RRC | | 1 | | | — | |
| Inactive | | | | | | |
| >TAI List for RRC | | 1 . . . | | | — | |
| Inactive Item | | <maxnoofTAIforInactive> | | | | |
| >>TAI | M | | 9.3.3.11 | | — | |
| Expected UE | O | | 9.3.1.93 | | — | |
| Behaviour | | | | | | |
| E-UTRA Paging eDRX | O | | 9.3.1.154 | | YES | ignore |
| Information | | | | | | |
| Extended UE Identity | O | | 9.3.3.52 | | YES | ignore |
| Index Value | | | | | | |
| UE Radio Capability | O | | 9.3.1.68 | | YES | ignore |
| for Paging | | | | | | |
| MICO All PLMN | O | | 9.3.1.194 | | YES | ignore |
| NR Paging eDRX | O | | 9.3.1.227 | | YES | ignore |
| Information | | | | | | |
| Paging Cause | O | | ENUMERATED (supported, . . . ) | This IE indicates | YES | ignore |
| Indication for Voice | | | | whether the UE | | |
| Service | | | | supports the | | |
| | | | | feature of | | |
| | | | | indication of | | |
| | | | | paging cause for | | |
| | | | | voice service. | | |
| PEIPS Assistance | O | | 9.3.1.232 | | YES | ignore |
| Information | | | | | | |
| CN MT data/ | | | ENUMERATED | This IE | YES | ignore |
| signalling | | | (CN, RAN, | indicates the | | |
| support indication | | | Both, | 5GC support | | |
| | | | none . . . ) | capabilities for | | |
| | | | | MT | | |
| | | | | data/signalling | | |
| | | | | handling in CN, | | |
| | | | | MT | | |
| | | | | data/signalling | | |
| | | | | handling in | | |
| | | | | RAN, or both. | | |

Furthermore, as an alternative to the ENUMERATED format above, in one embodiment, the CN MT data/signalling support indication can be encoded as a BITSTRING as shown below. This also applies to the next set of N2 messages, i.e., UE context modification, handover request, Path switch Acknowledge as well as during non-UE associated signalling, such as N2 setup and update procedure:

| | | | | | |
|---|---|---|---|---|---|
| CN MT data/ | M | BIT | Indicated the 5GC support | YES | ignore |
| signalling | | STRING | capabilities for MT data/ | | |
| support | | (SIZE(8)) | signalling handling. | | |
| indication | | | first bit: CN | | |
| | | | second bit: RAN | | |
| | | | Other bits reserved for | | |
| | | | future use. | | |
| | | | Value ‘1’ indicates | | |
| | | | support’, Value | | |
| | | | ‘0’ indicates | | |
| | | | ‘not supported’. | | |

### UE Context Modification

When AMF send NGAP UE Context Modification Request message (see TS 38.413) to NG-RAN, it can include the MT data/signalling handling capability information as part of the “Core Network Assistance Information for RRC_INACTIVE” IE or a separate IE.
Direction: AMF→NG-RAN node

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.3.1.1 | | YES | reject |
| AMF UE NGAP ID | M | 9.3.3.1 | | YES | reject |
| RAN UE NGAP ID | M | 9.3.3.2 | | YES | reject |
| RAN Paging Priority | O | 9.3.3.15 | | YES | ignore |
| Security Key | O | 9.3.1.87 | | YES | reject |
| Index to | O | 9.3.1.61 | | YES | ignore |
| RAT/Frequency | | | | | |
| Selection Priority | | | | | |
| UE Aggregate | O | 9.3.1.58 | | YES | ignore |
| Maximum Bit Rate | | | | | |
| UE Security | O | 9.3.1.86 | | YES | reject |
| Capabilities | | | | | |
| Core Network | O | 9.3.1.15 | | YES | ignore |
| Assistance | | | | | |
| Information for RRC | | | | | |
| INACTIVE | | | | | |
| Emergency Fallback | O | 9.3.1.26 | | YES | reject |
| Indicator | | | | | |
| New AMF UE NGAP ID | O | AMF UE NGAP ID | | YES | reject |
| | | 9.3.3.1 | | | |
| RRC Inactive | O | 9.3.1.91 | | YES | ignore |
| Transition Report | | | | | |
| Request | | | | | |
| New GUAMI | O | GUAMI | | YES | reject |
| | | 9.3.3.3 | | | |
| CN Assisted RAN | O | 9.3.1.119 | | YES | ignore |
| Parameters Tuning | | | | | |
| SRVCC Operation | O | 9.3.1.128 | | YES | ignore |
| Possible | | | | | |
| IAB Authorized | O | 9.3.1.129 | | YES | ignore |
| NR V2X Services | O | 9.3.1.146 | | YES | ignore |
| Authorized | | | | | |
| LTE V2X Services | O | 9.3.1.147 | | YES | ignore |
| Authorized | | | | | |
| NR UE Sidelink | O | 9.3.1.148 | This IE applies | YES | ignore |
| Aggregate Maximum | | | only if the UE is | | |
| Bit Rate | | | authorized for | | |
| | | | NR V2X | | |
| | | | services. | | |
| LTE UE Sidelink | O | 9.3.1.149 | This IE applies | YES | ignore |
| Aggregate Maximum | | | only if the UE is | | |
| Bit Rate | | | authorized for | | |
| | | | LTE V2X | | |
| | | | services. | | |
| PC5 QoS Parameters | O | 9.3.1.150 | This IE applies | YES | ignore |
| | | | only if the UE is | | |
| | | | authorized for | | |
| | | | NR V2X | | |
| | | | services. | | |
| UE Radio Capability | O | 9.3.1.142 | | YES | reject |
| ID | | | | | |
| RG Level Wireline | O | OCTET STRING | Specified in TS | YES | ignore |
| Access | | | 23.316 [34]. | | |
| Characteristics | | | Indicates the | | |
| | | | wireline access | | |
| | | | technology | | |
| | | | specific QoS | | |
| | | | information | | |
| | | | corresponding to | | |
| | | | a specific | | |
| | | | wireline access | | |
| | | | subscription. | | |
| Time Synchronisation | O | 9.3.1.220 | | YES | ignore |
| Assistance | | | | | |
| Information | | | | | |
| QMC Configuration | O | 9.3.1.223 | | YES | ignore |
| Information | | | | | |
| QMC Deactivation | O | 9.3.1.222 | | YES | ignore |
| UE Slice Maximum | O | 9.3.1.231 | | YES | ignore |
| Bit Rate List | | | | | |
| Management Based | O | MDT PLMN | | YES | ignore |
| MDT PLMN | | Modification List | | | |
| Modification List | | 9.3.1.243 | | | |
| 5G ProSe Authorized | O | 9.3.1.233 | | YES | ignore |
| 5G ProSe UE PC5 | O | NR UE | This IE applies | YES | ignore |
| Aggregate Maximum | | Sidelink | only if the UE is | | |
| Bit Rate | | Aggregate | authorized for | | |
| | | Maximum Bit | 5G ProSe | | |
| | | Rate | services. | | |
| | | 9.3.1.148 | | | |
| 5G ProSe PC5 QoS | O | 9.3.1.234 | This IE applies | YES | ignore |
| Parameters | | | only if the UE is | | |
| | | | authorized for | | |
| | | | 5G ProSe | | |
| | | | services. | | |
| CN MT data/signalling | | ENUMERATED | This IE | YES | ignore |
| support indication | | (CN, RAN, | indicates the | | |
| | | Both, . . . ) | 5GC support | | |
| | | | capabilities for | | |
| | | | MT | | |
| | | | data/signalling | | |
| | | | handling in CN, | | |
| | | | MT | | |
| | | | data/signalling | | |
| | | | handling in | | |
| | | | RAN, or both. | | |

During NGAP handover/N2 handover, when AMF send NGAP Handover Request message (see TS 38.413) to NG-RAN, it can include the MT data/signalling handling capability information as part of the “Core Network Assistance Information for RRC_INACTIVE” IE or a separate IE.

This message is sent by the AMF to the target NG-RAN node to request the preparation of resources.
Direction: AMF→NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | reject |
| Handover Type | M | | 9.3.1.22 | | YES | reject |
| Cause | M | | 9.3.1.2 | | YES | ignore |
| UE Aggregate | M | | 9.3.1.58 | | YES | reject |
| Maximum Bit Rate | | | | | | |
| Core Network | O | | 9.3.1.15 | | YES | ignore |
| Assistance | | | | | | |
| Information for RRC | | | | | | |
| INACTIVE | | | | | | |
| UE Security | M | | 9.3.1.86 | | YES | reject |
| Capabilities | | | | | | |
| Security Context | M | | 9.3.1.88 | | YES | reject |
| New Security Context | O | | 9.3.1.55 | | YES | reject |
| Indicator | | | | | | |
| NASC | O | | NAS-PDU | Refers to either | YES | reject |
| | | | 9.3.3.4 | the “Intra N1 | | |
| | | | | mode NAS | | |
| | | | | transparent | | |
| | | | | container” or the | | |
| | | | | “S1 mode to N1 | | |
| | | | | mode NAS | | |
| | | | | transparent | | |
| | | | | container”, the | | |
| | | | | details of the IE | | |
| | | | | definition and the | | |
| | | | | encoding | | |
| | | | | arespecified in | | |
| | | | | TS 24.501 [26]. | | |
| PDU Session | | 1 | | | YES | reject |
| Resource Setup List | | | | | | |
| >PDU Session | | 1 . . . | | | — | |
| Resource Setup | | <maxnoofPDUSessions> | | | | |
| Item | | | | | | |
| >>PDU Session ID | M | | 9.3.1.50 | | — | |
| >>S-NSSAI | M | | 9.3.1.24 | | — | |
| >>Handover | M | | OCTET STRING | Containing the | — | |
| Request Transfer | | | | PDU Session | | |
| | | | | Resource Setup | | |
| | | | | Request | | |
| | | | | Transfer IE | | |
| | | | | specified in | | |
| | | | | subclause | | |
| | | | | 9.3.4.1. | | |
| >>PDU Session | O | | Expected UE | Expected UE | YES | ignore |
| Expected UE Activity | | | Activity Behaviour | Activity | | |
| Behaviour | | | 9.3.1.94 | Behaviour for the | | |
| | | | | PDU Session. | | |
| Allowed NSSAI | M | | 9.3.1.31 | Indicates the S- | YES | reject |
| | | | | NSSAIs | | |
| | | | | permitted by the | | |
| | | | | network. | | |
| Trace Activation | O | | 9.3.1.14 | | YES | ignore |
| Masked IMEISV | O | | 9.3.1.54 | | YES | ignore |
| Source to Target | M | | 9.3.1.20 | | YES | reject |
| Transparent Container | | | | | | |
| Mobility Restriction List | O | | 9.3.1.85 | | YES | ignore |
| Location Reporting | O | | 9.3.1.65 | | YES | ignore |
| Request Type | | | | | | |
| RRC Inactive | O | | 9.3.1.91 | | YES | ignore |
| Transition Report | | | | | | |
| Request | | | | | | |
| GUAMI | M | | 9.3.3.3 | | YES | reject |
| Redirection for Voice | O | | 9.3.1.116 | | YES | ignore |
| EPS Fallback | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| IAB Authorized | O | | 9.3.1.129 | | YES | reject |
| Enhanced Coverage | O | | 9.3.1.140 | | YES | ignore |
| Restriction | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum | | | | only if the UE is | | |
| Bit Rate | | | | authorized for | | |
| | | | | NR V2X | | |
| | | | | services. | | |
| LTE UE Sidelink | O | | 9.3.1.149 | This IE applies | YES | ignore |
| Aggregate Maximum | | | | only if the UE is | | |
| Bit Rate | | | | authorized for | | |
| | | | | LTE V2X | | |
| | | | | services. | | |
| PC5 QoS Parameters | O | | 9.3.1.150 | This IE applies | YES | ignore |
| | | | | only if the UE is | | |
| | | | | authorized for | | |
| | | | | NR V2X | | |
| | | | | services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| Management Based | O | | MDT PLMN List | | YES | ignore |
| MDT PLMN List | | | 9.3.1.168 | | | |
| UE Radio Capability ID | O | | 9.3.1.142 | | YES | reject |
| Extended Connected | O | | 9.3.3.31 | | YES | ignore |
| Time | | | | | | |
| Time Synchronisation | O | | 9.3.1.220 | | YES | ignore |
| Assistance Information | | | | | | |
| UE Slice Maximum Bit | O | | 9.3.1.231 | | YES | ignore |
| Rate List | | | | | | |
| 5G ProSe Authorized | O | | 9.3.1.233 | | YES | ignore |
| 5G ProSe UE PC5 | O | | NR UE | This IE applies | YES | ignore |
| Aggregate Maximum | | | Sidelink | only if the UE is | | |
| Bit Rate | | | Aggregate Maximum | authorized for | | |
| | | | Bit Rate | 5G ProSe | | |
| | | | 9.3.1.148 | services. | | |
| 5G ProSe PC5 QoS | O | | 9.3.1.234 | This IE applies | YES | ignore |
| Parameters | | | | only if the UE is | | |
| | | | | authorized for | | |
| | | | | 5G ProSe | | |
| | | | | services. | | |
| CN MT | | | ENUMERATED | This IE | YES | ignore |
| data/signalling | | | (CN, RAN, | indicates the | | |
| support indication | | | Both, none . . . ) | 5GC support | | |
| | | | | capabilities for | | |
| | | | | MT | | |
| | | | | data/signalling | | |
| | | | | handling in CN, | | |
| | | | | MT | | |
| | | | | data/signalling | | |
| | | | | handling in | | |
| | | | | RAN, or both. | | |

### Path Switch Request Acknowledge

During XNAP handover/Xn handover, when AMF send NGAP Path Switch Request Acknowledge message (see TS 38.413) to NG-RAN, it can include the MT data/signalling handling capability information as part of the “Core Network Assistance Information for RRC_INACTIVE” IE or a separate IE.

This message is sent by the AMF to inform the NG-RAN node that the path switch has been successfully completed in the 5GC.
Direction: AMF→NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF UE NGAP ID | M | | 9.3.3.1 | | YES | ignore |
| RAN UE NGAP ID | M | | 9.3.3.2 | | YES | ignore |
| UE Security | O | | 9.3.1.86 | | YES | reject |
| Capabilities | | | | | | |
| Security Context | M | | 9.3.1.88 | | YES | reject |
| New Security Context | O | | 9.3.1.55 | | YES | reject |
| Indicator | | | | | | |
| PDU Session | | 1 | | | YES | ignore |
| Resource Switched | | | | | | |
| List | | | | | | |
| >PDU Session | | 1 . . . | | | — | |
| Resource Switched | | <maxnoofPDUSessions> | | | | |
| Item | | | | | | |
| >>PDU Session ID | M | | 9.3.1.50 | | — | |
| >>Path Switch | M | | OCTET STRING | Containing the | — | |
| Request | | | | Path Switch | | |
| Acknowledge | | | | Request | | |
| Transfer | | | | Acknowledge | | |
| | | | | Transfer IE | | |
| | | | | specified in | | |
| | | | | subclause | | |
| | | | | 9.3.4.9. | | |
| >>PDU Session | O | | Expected UE | Expected UE | YES | ignore |
| Expected UE Activity | | | Activity Behaviour | Activity | | |
| Behaviour | | | 9.3.1.94 | Behaviour for the | | |
| | | | | PDU Session. | | |
| PDU Session | | 0 . . . 1 | | | YES | ignore |
| Resource Released | | | | | | |
| List | | | | | | |
| >PDU Session | | 1 . . . | | | — | |
| Resource Released | | <maxnoofPDUSessions> | | | | |
| Item | | | | | | |
| >>PDU Session ID | M | | 9.3.1.50 | | — | |
| >>Path Switch | M | | OCTET STRING | Containing the | — | |
| Request | | | | Path Switch | | |
| Unsuccessful | | | | Request | | |
| Transfer | | | | Unsuccessful | | |
| | | | | Transfer IE | | |
| | | | | specified in | | |
| | | | | subclause | | |
| | | | | 9.3.4.20. | | |
| Allowed NSSAI | M | | 9.3.1.31 | Indicates the | YES | reject |
| | | | | S-NSSAIs | | |
| | | | | permitted by the | | |
| | | | | network. | | |
| Core Network | O | | 9.3.1.15 | | YES | ignore |
| Assistance | | | | | | |
| Information for RRC | | | | | | |
| INACTIVE | | | | | | |
| RRC Inactive | O | | 9.3.1.91 | | YES | ignore |
| Transition Report | | | | | | |
| Request | | | | | | |
| Criticality Diagnostics | O | | 9.3.1.3 | | YES | ignore |
| Redirection for Voice | O | | 9.3.1.116 | | YES | ignore |
| EPS Fallback | | | | | | |
| CN Assisted RAN | O | | 9.3.1.119 | | YES | ignore |
| Parameters Tuning | | | | | | |
| SRVCC Operation | O | | 9.3.1.128 | | YES | ignore |
| Possible | | | | | | |
| Enhanced Coverage | O | | 9.3.1.140 | | YES | ignore |
| Restriction | | | | | | |
| Extended Connected | O | | 9.3.3.31 | | YES | ignore |
| Time | | | | | | |
| UE Differentiation | O | | 9.3.1.144 | | YES | ignore |
| Information | | | | | | |
| NR V2X Services | O | | 9.3.1.146 | | YES | ignore |
| Authorized | | | | | | |
| LTE V2X Services | O | | 9.3.1.147 | | YES | ignore |
| Authorized | | | | | | |
| NR UE Sidelink | O | | 9.3.1.148 | This IE applies | YES | ignore |
| Aggregate Maximum | | | | only if the UE is | | |
| Bit Rate | | | | authorized for | | |
| | | | | NR V2X | | |
| | | | | services. | | |
| LTE UE Sidelink | O | | 9.3.1.149 | This IE applies | YES | ignore |
| Aggregate Maximum | | | | only if the UE is | | |
| Bit Rate | | | | authorized for | | |
| | | | | LTE V2X | | |
| | | | | services. | | |
| PC5 QoS Parameters | O | | 9.3.1.150 | This IE applies | YES | ignore |
| | | | | only if the UE is | | |
| | | | | authorized for | | |
| | | | | NR V2X | | |
| | | | | services. | | |
| CE-mode-B Restricted | O | | 9.3.1.155 | | YES | ignore |
| UE User Plane CIoT | O | | 9.3.1.160 | | YES | ignore |
| Support Indicator | | | | | | |
| UE Radio Capability ID | O | | 9.3.1.142 | | YES | reject |
| Management Based | O | | MDT PLMN List | | YES | ignore |
| MDT PLMN List | | | 9.3.1.168 | | | |
| Time Synchronisation | O | | 9.3.1.220 | | YES | ignore |
| Assistance Information | | | | | | |
| 5G ProSe Authorized | O | | 9.3.1.233 | | YES | ignore |
| 5G ProSe UE PC5 | O | | NR UE | This IE applies | YES | ignore |
| Aggregate Maximum | | | Sidelink | only if the UE is | | |
| Bit Rate | | | Aggregate Maximum | authorized for | | |
| | | | Bit Rate | 5G ProSe | | |
| | | | 9.3.1.148 | services. | | |
| 5G ProSe PC5 QoS | O | | 9.3.1.234 | This IE applies | YES | ignore |
| Parameters | | | | only if the UE is | | |
| | | | | authorized for | | |
| | | | | 5G ProSe | | |
| | | | | services. | | |
| CN MT | | | ENUMERATED | This IE | YES | ignore |
| data/signalling | | | (CN, RAN, | indicates the | | |
| support indication | | | Both, none . . . ) | 5GC support | | |
| | | | | capabilities for | | |
| | | | | MT | | |
| | | | | data/signalling | | |
| | | | | handling in CN, | | |
| | | | | MT | | |
| | | | | data/signalling | | |
| | | | | handling in | | |
| | | | | RAN, or both. | | |

### N2 Setup Response

During N2 (NG-AP) interface setup, when AMF sends the Setup Response message (see TS 38.413) to NG-RAN, it can include the MT data/signalling handling capability information in a separate IE contained in the message.

This message is sent by the AMF to transfer application layer information for an N2 interface instance.
Direction: AMF→NG-RAN node

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF Name | M | | 9.3.3.21 | | YES | reject |
| Served GUAMI List | | 1 | | | YES | reject |
| >Served GUAMI Item | | 1 . . . | | | — | |
| >>GUAMI | M | <maxnoofServedGUAMIs> | 9.3.3.3 | | — | |
| >>Backup AMF Name | O | | AMF Name | | — | |
| | | | 9.3.3.21 | | | |
| >>GUAMI Type | O | | ENUMERATED (native, | | YES | ignore |
| | | | mapped, . . . ) | | | |
| Relative AMF Capacity | M | | 9.3.1.32 | | YES | ignore |
| PLMN Support List | | 1 | | | YES | reject |
| >PLMN Support Item | | 1 . . . | | | — | |
| >>PLMN Identity | M | <maxnoofPLMNs> | 9.3.3.5 | | — | |
| >>Slice Support List | M | | 9.3.1.17 | Supported S- | — | |
| | | | | NSSAIs per PLMN | | |
| | | | | or per SNPN. | | |
| >>NPN Support | O | | 9.3.3.44 | If NID IE is | YES | reject |
| | | | | included, it | | |
| | | | | identifies a SNPN | | |
| | | | | together with the | | |
| | | | | PLMN Identity IE. | | |
| >>Extended Slice | O | | 9.3.1.191 | Additional | YES | reject |
| Support List | | | | Supported S- | | |
| | | | | NSSAIs per PLMN | | |
| | | | | or per SNPN. | | |
| >>Onboarding Support | O | | ENUMERATED (true, . . . ) | Indication of | YES | ignore |
| | | | | onboarding | | |
| | | | | support. | | |
| Criticality Diagnostics | O | | 9.3.1.3 | | YES | ignore |
| UE Retention Information | O | | 9.3.1.117 | | YES | ignore |
| IAB Supported | O | | ENUMERATED (true, . . . ) | Indication of | YES | ignore |
| | | | 9.3.3.51 | support for IAB. | | |
| Extended AMF Name | O | | | | YES | ignore |
| CN MT data/signalling | | | ENUMERATED | This IE indicates | YES | ignore |
| support indication | | | (CN, RAN, Both, | the 5GC support | | |
| | | | none . . . ) | capabilities for | | |
| | | | | MT | | |
| | | | | data/signalling | | |
| | | | | handling in CN, | | |
| | | | | MT | | |
| | | | | data/signalling | | |
| | | | | handling in RAN, | | |
| | | | | or both. | | |

Furthermore, during NG-AP interface configuration update, when AMF sends the AMF Configuration Update message (see TS 38.413) to NG-RAN, it can include the MT data/signalling handling capability information in a separate IE contained in the message.

### AMF Configuration Update

This message is sent by the AMF to transfer updated information for an NG-C interface instance.
Direction: AMF→NG-RAN node

| | | | IE type and | Semantics | | Assigned |
|---|---|---|---|---|---|---|
| IE/Group Name | Presence | Range | reference | description | Criticality | Criticality |
| Message Type | M | | 9.3.1.1 | | YES | reject |
| AMF Name | O | | 9.3.3.21 | | YES | reject |
| Served GUAMI List | | 0 . . . 1 | | | YES | reject |
| >Served GUAMI Item | | 1 . . . | | | — | |
| >>GUAMI | M | <maxnoofServedGUAMIs> | 9.3.3.3 | | — | |
| >>Backup AMF | O | | AMF Name | | — | |
| Name | | | 9.3.3.21 | | | |
| >>GUAMI Type | O | | ENUMERATED (native, | | YES | ignore |
| | | | mapped, . . . ) | | | |
| Relative AMF Capacity | O | | 9.3.1.32 | | YES | ignore |
| PLMN Support List | | 0 . . . 1 | | | YES | reject |
| >PLMN Support Item | | 1 . . . | | | — | |
| >>PLMN Identity | M | <maxnoofPLMNs> | 9.3.3.5 | | — | |
| >>Slice Support List | M | | 9.3.1.17 | Supported S- | — | |
| | | | | NSSAIs per | | |
| | | | | PLMN or per | | |
| | | | | SNPN. | | |
| >>NPN Support | O | | 9.3.3.44 | If the NID IE is | YES | reject |
| | | | | included, it | | |
| | | | | identifies a | | |
| | | | | SNPN together | | |
| | | | | with the PLMN | | |
| | | | | Identity IE. | | |
| >>Extended Slice | O | | 9.3.1.191 | Additional | YES | reject |
| Support List | | | | Supported S- | | |
| | | | | NSSAIs per | | |
| | | | | PLMN or per | | |
| | | | | SNPN. | | |
| >>Onboarding | O | | ENUMERATED (true, . . . ) | Indication of | YES | ignore |
| Support | | | | onboarding | | |
| | | | | support. | | |
| AMF TNL | | 0 . . . 1 | | | YES | ignore |
| Association to Add | | | | | | |
| List | | | | | | |
| >AMF TNL | | 1 . . . | | | — | |
| Association to Add | | <maxnoofTNLAssociations> | | | | |
| Item | | | | | | |
| >>AMF TNL | M | | CP Transport | AMF Transport | — | |
| Association Address | | | Layer Information | Layer | | |
| | | | 9.3.2.6 | information used | | |
| | | | | to set up the new | | |
| | | | | TNL association. | | |
| >>TNL Association | O | | 9.3.2.9 | | — | |
| Usage | | | | | | |
| >>TNL Address | M | | 9.3.2.10 | | — | |
| Weight Factor | | | | | | |
| AMF TNL | | 0 . . . 1 | | | YES | ignore |
| Association to | | | | | | |
| Remove List | | | | | | |
| >AMF TNL | | 1 . . . | | | — | |
| Association to | | <maxnoofTNLAssociations> | | | | |
| Remove Item | | | | | | |
| >>AMF TNL | M | | CP Transport | Transport Layer | — | |
| Association Address | | | Layer | Address of the | | |
| | | | Information | AMF. | | |
| | | | 9.3.2.6 | | | |
| >>TNL Association | O | | CP Transport | Transport Layer | YES | reject |
| Transport Layer | | | Layer Address | Address of the | | |
| Address NG-RAN | | | 9.3.2.6 | NG-RAN node. | | |
| AMF TNL | | 0 . . . 1 | | | YES | ignore |
| Association to | | | | | | |
| Update List | | | | | | |
| >AMF TNL | | 1 . . . | | | — | |
| Association to | | <maxnoofTNLAssociations> | | | | |
| Update Item | | | | | | |
| >>AMF TNL | M | | CP Transport | AMF Transport | — | |
| Association Address | | | Layer | Layer | | |
| | | | Information | information used | | |
| | | | 9.3.2.6 | to identify the | | |
| | | | | TNL association | | |
| | | | | to be updated. | | |
| >>TNL Association | O | | 9.3.2.9 | | — | |
| Usage | | | | | | |
| >>TNL Address | O | | 9.3.2.10 | | — | |
| Weight Factor | | | | | | |
| Extended AMF Name | O | | 9.3.3.51 | | YES | ignore |
| CN MT data/signalling | | | ENUMERATED | This IE indicates | YES | ignore |
| support indication | | | (CN, RAN, Both, | the 5GC support | | |
| | | | none . . . ) | capabilities for | | |
| | | | | MT | | |
| | | | | data/signalling | | |
| | | | | handling in CN, | | |
| | | | | MT | | |
| | | | | data/signalling | | |
| | | | | handling in RAN, | | |
| | | | | or both. | | |

According to the embodiments, the CN Mobile Terminating (MT) data/signalling capability or support indication can indicate whether
CN supports all the functionalities specified in 3GPP for MT data/signalling handling (e.g., buffering) in the CN for UEs in RRC INACTIVE with long eDRX,
CN supports all the functionalities specified in 3GPP for MT data/signalling handling (e.g., buffering) in the NG-RAN for UEs in RRC INACTIVE with long eDRX, or
CN supports all the functionalities specified in 3GPP for MT data/signalling handling (e.g., buffering) in both the CN and the NG_RAN for UEs in RRC INACTIVE with long eDRX, or
none (optional). Alternatively, absence of the capability indication is similar to receiving an indication with value “none” or “not supported” and can be interpreted by the NG-RAN as the CN does not support the functionalities specified in 3GPP for MT data/signalling handling (e.g., buffering) in the CN and the NG-RAN.

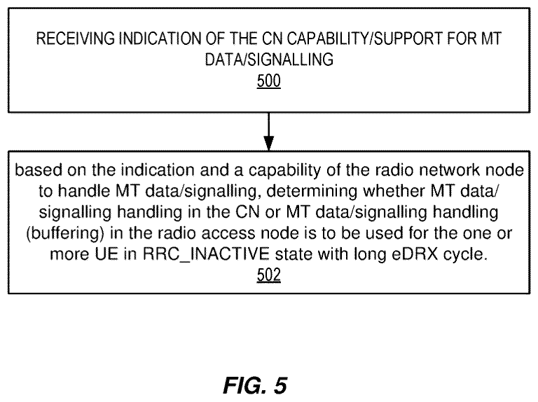

FIG. 5 is a flow chart of a method in an NG-RAN node according to some embodiments. The NG-RAN node receives (step 500) the CN MT data/signalling capability indication from any of the N2 messages (UE specific or non-UE signalling) as described above as part of FIG. 4.

The NG-RAN uses (step 502) the information for the decision when entering RRC_INACTIVE state with long eDRX value. More specifically, the NG-RAN uses this information, potentially, together with other input parameters, to decide if CN MT data/signalling handling or NG-RAN MT data/signalling handling shall be used for UEs in long eDRX with RRC_INACTIVE state.
When the support/capability indication indicates CN, it means CN (e.g., 5GC) supports all the functionalities specified in 3GPP for MT data/signalling handling in the CN when the UE is not reachable in RRC_INACTIVE state. In this case, the NG-RAN determines the CN handles the MT data/signalling for UEs in RRC Inactive with long eDRX cycle if CN handling is also supported by NG-RAN. Otherwise, long eDRX can't be used for RRC_INACTIVE (e.g. legacy long eDRX for IDLE mode function may be applied for the UE(s).
When the support/capability indication indicates the NG-RAN, it means the CN (e.g., 5G CN) supports all the functionalities specified in 3GPP for MT data/signalling handling in the NG-RAN when the UE is not reachable in RRC_INACTIVE state, including UE context retrieval between two NG-RAN nodes via the CN. In this case, the NG-RAN determines that it should handle the MT data/signalling for UEs in RRC Inactive with long eDRX cycle.
When the parameter indicates both, it means CN (e.g., 5GC) supports all the functionalities specified in 3GPP for MT data/signalling handling in RAN and CN. The NG-RAN determines whether the CN or the NG-RAN should handle MT data/signalling for UEs in RRC INACTIVE with long eDRX based on the NG-RAN capability of handling MT data/signalling and other parameters, such as internal/local policies, resources, traffic pattern, etc.
When the CN (e.g., 5GC) does not support any of the functionalities, the NG-RAN does not receive any indication. Alternatively, it can receive the indication that indicates a “none” or “not supported” codepoint. In this case, the NG-RAN can't apply long eDRX for RRC_INACTIVE regardless of the NG-RAN supporting the capability.

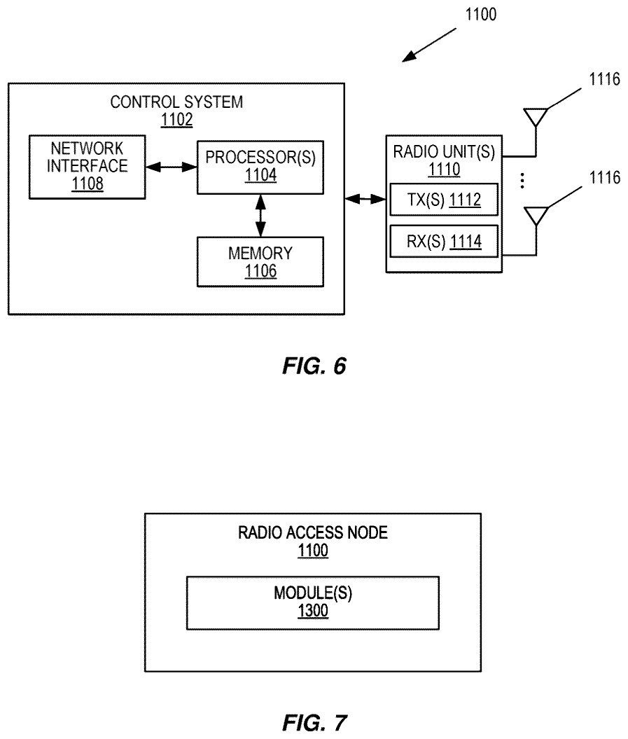

FIG. 6 is a schematic block diagram of a radio access node 1100 according to some embodiments of the present disclosure. The radio access node 1100 may be, for example, a base station 302 or 306. As illustrated, the radio access node 1100 includes a control system 1102 that includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, the radio access node 1100 includes one or more radio units 1110 that each includes one or more transmitters 1112 and one or more receivers 1114 coupled to one or more antennas 1116. The radio units 1110 may be referred to or be part of radio interface circuitry. In some embodiments, the radio unit(s) 1110 is external to the control system 1102 and connected to the control system 1102 via, e.g., a wired connection (e.g., an optical cable). However, in some other embodiments, the radio unit(s) 1110 and potentially the antenna(s) 1116 are integrated together with the control system 1102. The one or more processors 1104 operate to provide one or more functions of a radio access node 1100 as described herein. In some embodiments, the function(s) are implemented in software that is stored, e.g., in the memory 1106 and executed by the one or more processors 1104.

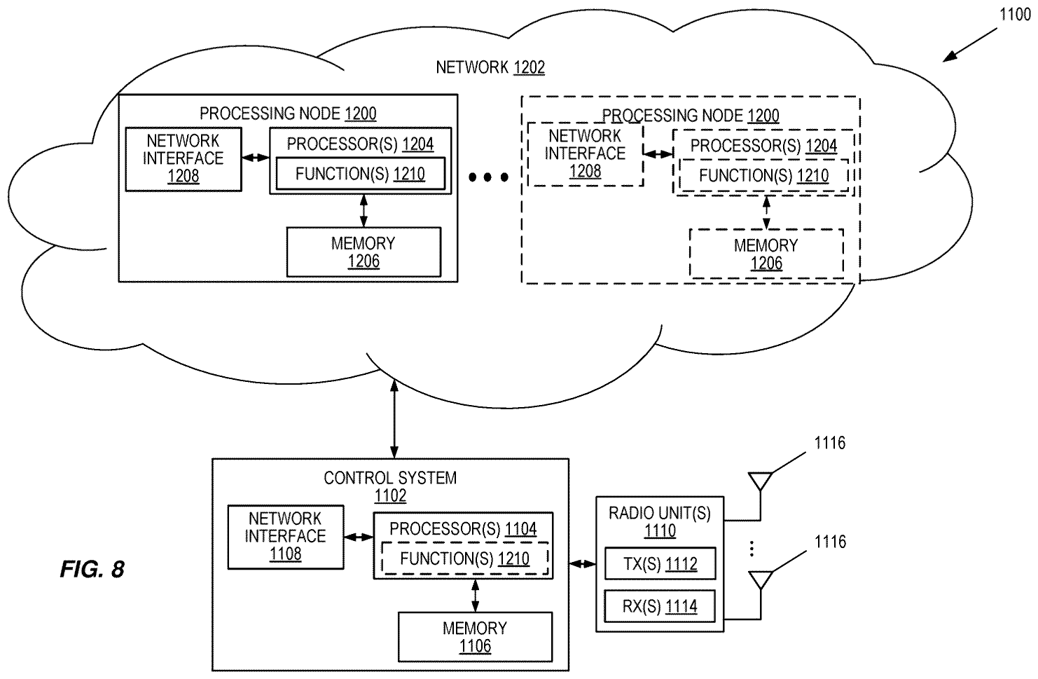

FIG. 8 is a schematic block diagram that illustrates a virtualized embodiment of the radio access node 1100 according to some embodiments of the present disclosure. This discussion is equally applicable to other types of network nodes. Further, other types of network nodes may have similar virtualized architectures.

As used herein, a “virtualized” radio access node is an implementation of the radio access node 1100 in which at least a portion of the functionality of the radio access node 1100 is implemented as a virtual component(s) (e.g., via a virtual machine(s) executing on a physical processing node(s) in a network(s)). As illustrated, in this example, the radio access node 1100 includes the control system 1102 that includes the one or more processors 1104 (e.g., CPUs, ASICs, FPGAs, and/or the like), the memory 1106, and the network interface 1108 and the one or more radio units 1110 that each includes the one or more transmitters 1112 and the one or more receivers 1114 coupled to the one or more antennas 1116, as described above. The control system 1102 is connected to the radio unit(s) 1110 via, for example, an optical cable or the like. The control system 1102 is connected to one or more processing nodes 1200 coupled to or included as part of a network(s) 1202 via the network interface 1108. Each processing node 1200 includes one or more processors 1204 (e.g., CPUs, ASICs, FPGAs, and/or the like), memory 1206, and a network interface 1208.

In this example, functions 1210 of the radio access node 1100 described herein are implemented at the one or more processing nodes 1200 or distributed across the control system 1102 and the one or more processing nodes 1200 in any desired manner. In some particular embodiments, some or all of the functions 1210 of the radio access node 1100 described herein are implemented as virtual components executed by one or more virtual machines implemented in a virtual environment(s) hosted by the processing node(s) 1200. As will be appreciated by one of ordinary skill in the art, additional signaling or communication between the processing node(s) 1200 and the control system 1102 is used in order to carry out at least some of the desired functions 1210. Notably, in some embodiments, the control system 1102 may not be included, in which case the radio unit(s) 1110 communicate directly with the processing node(s) 1200 via an appropriate network interface(s).

In some embodiments, a computer program including instructions which, when executed by at least one processor, causes the at least one processor to carry out the functionality of radio access node 1100 or a node (e.g., a processing node 1200) implementing one or more of the functions 1210 of the radio access node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

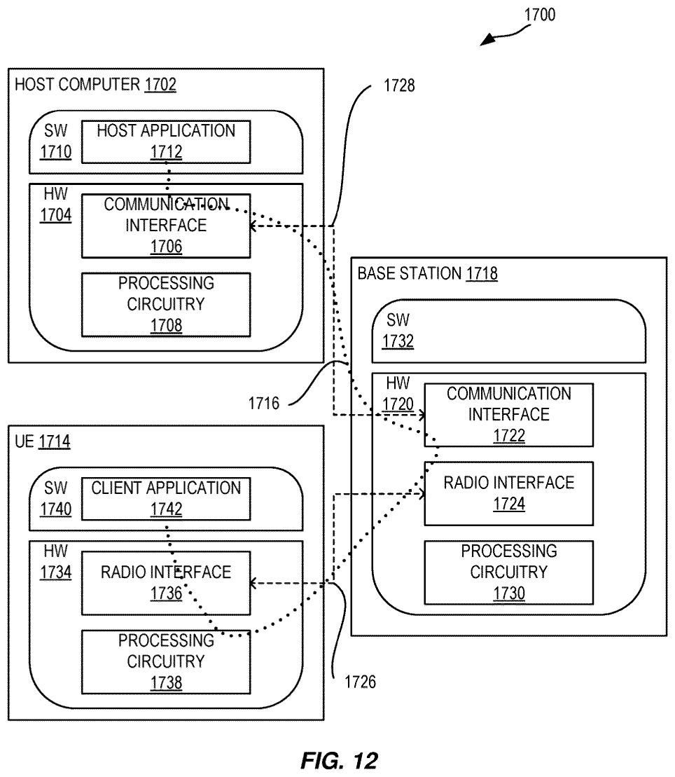

FIG. 7 is a schematic block diagram of the radio access node 1100 according to some other embodiments of the present disclosure. The radio access node 1100 includes one or more modules 1300, each of which is implemented in software. The module(s) 1300 provide the functionality of the radio access node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1200 and the control system 1102.

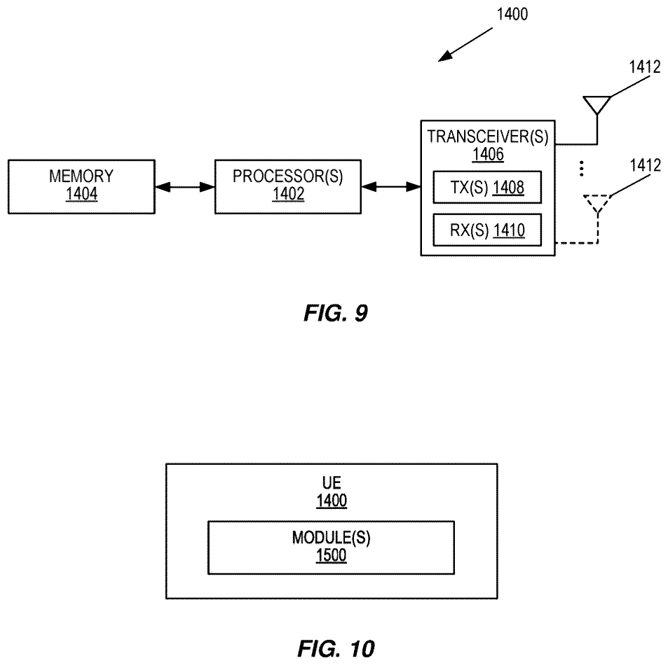

FIG. 9 is a schematic block diagram of a UE 1400 according to some embodiments of the present disclosure. As illustrated, the UE 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1406 includes radio-front end circuitry connected to the antenna(s) 1412 that is configured to condition signals communicated between the antenna(s) 1412 and the processor(s) 1402, as will be appreciated by on of ordinary skill in the art. The processors 1402 are also referred to herein as processing circuitry. The transceivers 1406 are also referred to herein as radio circuitry. In some embodiments, the functionality of the UE 1400 described above may be fully or partially implemented in software that is, e.g., stored in the memory 1404 and executed by the processor(s) 1402. Note that the UE 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the UE 1400 and/or allowing output of information from the UE 1400), a power supply (e.g., a battery and associated power circuitry), etc.

In some embodiments, a computer program including instructions which, when executed by at least one processor, causes the at least one processor to carry out the functionality of the UE 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 10 is a schematic block diagram of the UE 1400 according to some other embodiments of the present disclosure. The UE 1400 includes one or more modules 1500, each of which is implemented in software. The module(s) 1500 provide the functionality of the UE 1400 described herein.

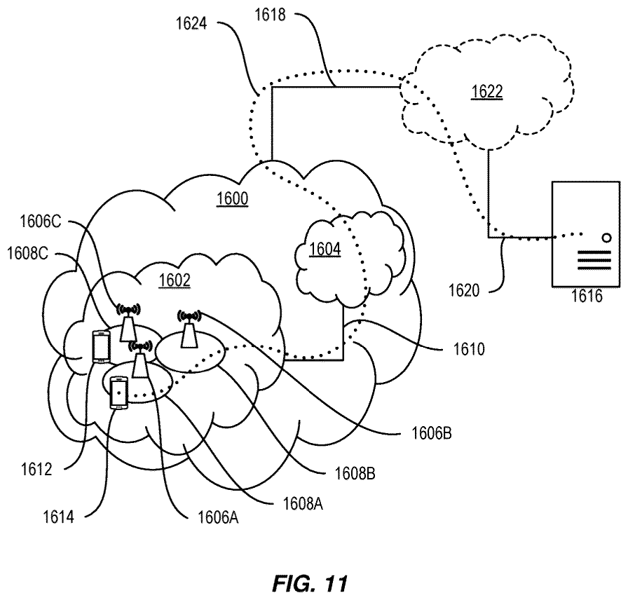

FIG. 11 illustrates a communication system according to some embodiments of the present disclosure. With reference to FIG. 11, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as NBs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 11 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

FIG. 12 illustrates a communication system according to some embodiments of the present disclosure. Example implementations, in accordance with an embodiment, of the UE, base station, and host computer discussed in the preceding paragraphs will now be described with reference to FIG. 12. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 12) served by the base station 1718. The communication interface 1722 may be configured to facilitate a connection 1728 to the host computer 1702. The connection 1728 may be direct or it may pass through a core network (not shown in FIG. 12) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 1714 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 12 may be similar or identical to the host computer 1616, one of the base stations 1606A, 1606B, 1606C, and one of the UEs 1612, 1614 of FIG. 11, respectively. This is to say, the inner workings of these entities may be as shown in FIG. 12 and independently, the surrounding network topology may be that of FIG. 11.

In FIG. 12, the OTT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment. More precisely, the teachings of these embodiments enables the MT data or signalling from OTT to be handled in the CN or NG-RAN thereby provide benefits such as minimizing packet loss, which leads to improved end-user performance.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer 1702's measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

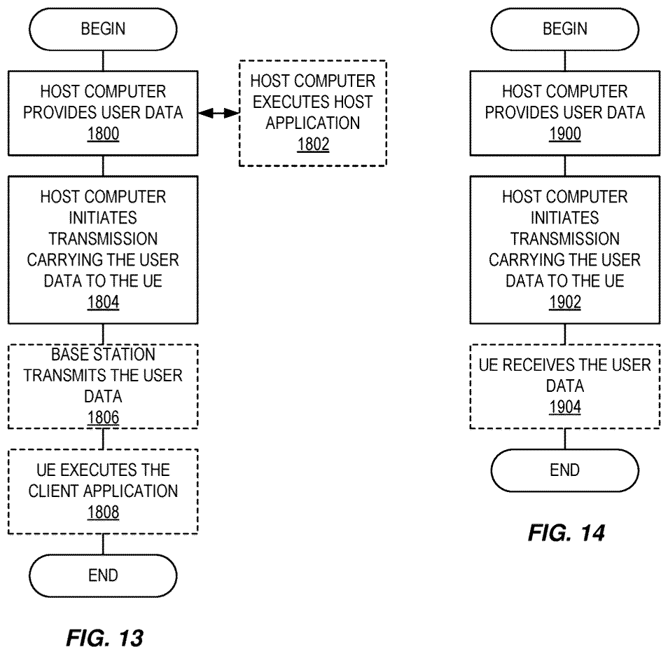

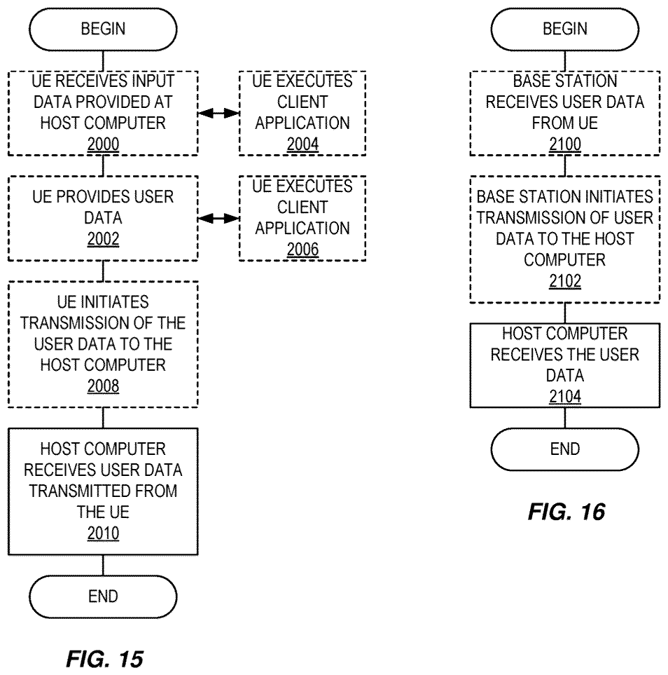

FIG. 13 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 13 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 14 is a flowchart illustrating a method implemented in a communication system, in accordance with one embodiment. The communication system includes a host computer, a base station, and a UE which may be those described with reference to FIGS. 11 and 12. For simplicity of the present disclosure, only drawing references to FIG. 14 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments—5G AMF

Embodiment 1: A method performed by a network function in a core network (CN), the method comprising:
determining a capability of the CN to support functionalities required for handling of Mobile Terminated (MT) data/signalling in the CN or Radio Access Network or both for one or more User Equipment (UE) in RRC INACTIVE with long eDRX cycle, and
indicating the capability to the Radio Access Network.

Embodiment 2: The method of embodiment 1 wherein the 5G network node comprises an Access and Mobility Management Function, AMF.

Embodiment 3: The method of embodiment 1 or 2 wherein the step of indicating the capability to the Radio Access Network comprises sending the capability in an INITIAL CONTEXT SETUP REQUEST message.

Embodiment 4: The method of embodiment 1 or 2 wherein the step of indicating the capability to the Radio Access Network comprises sending the capability in a UE CONTEXT MODIFICATION REQUEST message.

Embodiment 5: The method of embodiment 1 or 2 wherein the step of indicating the capability to the Radio Access Network comprises sending the capability in a HANDOVER REQUEST message.

Embodiment 6: The method of embodiment 1 or 2 wherein the step of indicating the capability to the Radio Access Network comprises sending the capability in a PATH SWITCH REQUEST ACKNOWLEDGE message.

Embodiment 7: The method of embodiment 1 or 2 wherein the step of indicating the capability to the Radio Access Network comprises sending the capability in a NG/N2 SETUP RESPONSE message.

Embodiment 8: The method of embodiment 1 or 2 wherein the step of indicating the capability to the Radio Access Network comprises sending the capability in a AMF CONFIGURATION UPDATE message.

Embodiment 9: The method of any of embodiments 1 to 8 wherein the capability is comprised in a CN Assistance Information for RRC INACTIVE Information Element.

### Group B Embodiments—Radio Access Node in RAN

Embodiment 10: A method performed by a radio network node in a Radio Access Network and connected to a Core network (CN), the method comprising:
receiving an indication of a capability of the CN to support functionalities required for handling of Mobile Terminated (MT) data/signalling in the CN or the Radio Access Network or both for one or more User Equipment (UE) in RRC INACTIVE with long eDRX cycle, and
based on the indication and a capability of the radio network node to handle MT data/signalling, determining whether MT data/signalling handling in the CN or MT data/signalling handling in the radio access node is to be used for the one or more UE in RRC_INACTIVE state with long eDRX cycle.

Embodiment 11: The method of embodiment 10 wherein determining MT data/signalling in the CN is to be used is based on the indication of the capability of the CN indicating the CN supports functionalities required for handling of Mobile Terminated (MT) data/signalling in the CN or both the Radio Access Network and the CN.

Embodiment 12: The method of embodiment 10 wherein determining MT data/signalling in the radio access node is to be used is based on the indication of the capability of the CN indicating the CN supports functionalities required for handling of Mobile Terminated (MT) data/signalling in the Radio Access Network or both the Radio Access Network and the CN and a radio network node capability of handling MT data/signalling.

Embodiment 13: The method of any of embodiments 10 to 12 wherein the indication of the capability is included in a CN Assistance Information for RRC INACTIVE Information Element.

Embodiment 14: The method of embodiment 10 wherein the step of receiving the indication of the capability comprises receiving the indication in an INITIAL CONTEXT SETUP REQUEST message.

Embodiment 15: The method of embodiment 10 wherein the step of receiving the indication of the capability comprises receiving the indication in a UE CONTEXT MODIFICATION REQUEST message.

Embodiment 16: The method of embodiment 10 wherein the step of receiving the indication of the capability comprises receiving the indication in a HANDOVER REQUEST message.

Embodiment 17: The method of embodiment 10 wherein the step of receiving the indication of the capability comprises receiving the indication in a PATH SWITCH REQUEST ACKNOWLEDGE message.

Embodiment 18: The method of embodiment 10 wherein the step of receiving the capability comprises receiving the indication of the indication in a NG/N2 SETUP RESPONSE message.

Embodiment 19: The method of embodiment 10 wherein the step of receiving the capability comprises receiving the indication of the indication in an AMF CONFIGURATION UPDATE message.

Embodiment 20: The method of embodiment 10 wherein the indication of the capability of the CN further indicates that the CN does not support functionalities required for handling Mobile Terminated (MT) data/signalling in both the CN and in the Radio Access Network.

Embodiment 21: The method of embodiment 20 wherein the indication is implicit (e.g., not received by the CN) or explicit (i.e., received by the CN).

Embodiment 22: The method of embodiment 20 wherein the method further comprises refraining from applying long eDRX for RRC_INACTIVE regardless of the capability of the radio access node to support MT data/signalling.

### Group C Embodiments—Apparatus

Embodiment 23: A network node implementing a network function comprising: processing circuitry configured to perform any of the steps of any of the Group A, embodiments.

Embodiment 24: The network node of embodiment 23, the network node comprising an Access and Mobility Management Function, AMF, node.

Embodiment 25: A radio network node comprising: processing circuitry configured to perform any of the steps of any of the Group B, embodiments.

Embodiment 26: The radio network node of embodiment 25, the radio network node comprising a gNB.

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | Third Generation Partnership Project |
| 5G | Fifth Generation |
| 5GC | Fifth Generation Core network |
| 5GS | Fifth Generation System |
| AF | Application Function |
| AMF | Access and Mobility Management Function |
| AN | Access Network |
| AP | Access Point |
| ASIC | Application Specific Integrated Circuit |
| AUSF | Authentication Server Function |
| CGI | Cell Global Identifier |
| CM | Configuration Management |
| CN | Core Network |
| CPU | Central Processing Unit |
| DL | Downlink |
| DN | Data Network |
| DRX | Discontinuous Reception |
| DSP | Digital Signal Processor |
| eDRX | Extended Discontinuous Reception |
| eNB | Enhanced or Evolved Node B |
| EPC | Evolved Packet Core |
| EPS | Evolved Packet System |
| E-UTRA | Evolved Universal Terrestrial Radio Access |
| E-UTRAN | Evolved Universal Terrestrial Radio Access Network |
| FPGA | Field Programmable Gate Array |
| gNB | New Radio Base Station |
| LTE | Long Term Evolution |
| MME | Mobility Management Entity |
| MT | Mobile-Terminated |
| MTC | Machine Type Communication |
| NAS | Non-Access Stratum |
| NEF | Network Exposure Function |
| NF | Network Function |
| NG | Next Generation (e.g., 5G) |
| NR | New Radio |
| NRF | Network Function Repository Function |
| NSSF | Network Slice Selection Function |
| OTT | Over-the-Top |
| PCF | Policy Control Function |
| PLMN | Public Land Mobile Network |
| RAM | Random Access Memory |
| RAN | Radio Access Network |
| RAT | Radio Access Technology |
| RNA | Radio Access Network Notification Area |
| RNTI | Radio Network Temporary Identifier |
| ROM | Read Only Memory |
| RRC | Radio Resource Control |
| RRH | Remote Radio Head |
| SMF | Session Management Function |
| TAI | Tracking Area Identity |
| TS | Technical Specification |
| UDM | Unified Data Management |
| UE | User Equipment |
| UPF | User Plane Function |
| UTRA | Universal Terrestrial Radio Access |
| UTRAN | Universal Terrestrial Radio Access Network |

Those skilled in the art will recognize improvements and modifications to the embodiments of the present disclosure. All such improvements and modifications are considered within the scope of the concepts disclosed herein.

1. A method performed by a network function in a core network (CN), the method comprising:
determining a capability of the CN to support handling of Mobile Terminated (MT) data/signalling for a User Equipment (UE) when in Radio Resource Control (RRC) INACTIVE state with long extended Discontinuous Reception (eDRX) cycle, and
transmitting to the Radio Access Network (RAN) serving the UE an indication indicating support of the CN for MT data/signalling handling.

2. The method of claim 1 wherein the 5G network node comprises an Access and Mobility Management Function, AMF.

3. The method of anyone of claims 1 and 2 wherein the step of transmitting the indication to the Radio Access Network comprises sending the indication in an INITIAL CONTEXT SETUP REQUEST message.

4. The method of anyone of claims 1 and 2 wherein the step of transmitting the indication to the Radio Access Network comprises sending the indication in a UE CONTEXT MODIFICATION REQUEST message.

5. The method of anyone of claims 1 and 2 wherein the step of transmitting the indication to the Radio Access Network comprises sending the indication in a HANDOVER REQUEST message.

6. The method of anyone of claims 1 and 2 wherein the step of transmitting the indication to the Radio Access Network comprises sending the indication in a PATH SWITCH REQUEST ACKNOWLEDGE message.

7. The method of anyone of claims 1 and 2 wherein the step of transmitting the indication to the Radio Access Network comprises sending the indication in a NG/N2 SETUP RESPONSE message.

8. The method of anyone of claims 1 and 2 wherein the step of transmitting the indication to the Radio Access Network comprises sending the indication in a AMF CONFIGURATION UPDATE message.

9. The method of anyone of claims 1 and 8 wherein the indication is transmitted to the RAN in a CN Assistance Information for RRC INACTIVE Information Element.

10. The method of claim 1 wherein the long eDRX cycle comprises DRX cycles of more than 10.24 seconds.

11. The method of claim 1 or 10 wherein the step of determining a capability of the CN to support handling of Mobile Terminated (MT) data/signalling for a User Equipment (UE) when in RRC state with long eDRX cycle comprises determining the capability to buffer MT data/signalling for the UE in RRC Inactive state with long eDRX cycle.

12. A method performed by a radio network node in a Radio Access Network (RAN) and connected to a Core network (CN), the method comprising.
receiving from the CN an indication indicating the CN support for MT data/signalling handling for a User Equipment (UE) to be used for the UE when in Radio Resource Control (RRC) INACTIVE state with long extended Discontinuous Reception (eDRX) cycle, and
based on the received indication, determining that MT data/signalling can be handled in the CN for the UE in RRC_INACTIVE state with long eDRX cycle.

13. The method of claim 12 wherein the indication is received from the CN in a CN Assistance Information for RRC INACTIVE Information Element.

14. The method of anyone of claims 12 and 13 wherein the step of receiving the indication comprises receiving the indication in an INITIAL CONTEXT SETUP REQUEST message.

15. The method of anyone of claims 12 and 13 wherein the step of receiving the indication comprises receiving the indication in a UE CONTEXT MODIFICATION REQUEST message.

16. The method of anyone of claims 12 and 13 wherein the step of receiving the indication comprises receiving the indication in a HANDOVER REQUEST message.

17. The method of anyone of claims 12 and 13 wherein the step of receiving the indication comprises receiving the indication in a PATH SWITCH REQUEST ACKNOWLEDGE message.

18. The method of anyone of claims 12 and 13 wherein the step of receiving the indication comprises receiving the indication in a NG/N2 SETUP RESPONSE message.

19. The method of anyone of claims 12 and 13 wherein the step of receiving the indication comprises receiving the indication in an AMF CONFIGURATION UPDATE message.

20. The method of claim 12 wherein the indication further indicates that the CN does not support handling Mobile Terminated (MT) data/signalling.

21. The method of claim 20 further comprising determining whether to handle MT data/signalling at the RAN node.

22. The method of claim 14 wherein the long eDRX cycle comprises DRX cycles of more than 10.24 seconds.

23. The method of claim 14 or 22 wherein the indication indicating the CN support for MT data/signalling handling for a User Equipment (UE) to be used for the UE when in Radio Resource Control (RRC) INACTIVE state with long extended Discontinuous Reception (eDRX) cycle corresponds to the CN able to buffer MT data/signalling for the UE in RRC Inactive state with long eDRX cycle.

24. A network node implementing a network function in a Core Network (CN), the network node comprising processing circuitry and memory comprising instructions which when executed by the processing circuitry performs any of the method claims 1-13.

25. A radio network node comprising processing circuitry and memory comprising instructions which when executed by the processing circuitry performs any of the method claims 14-23.

26. The radio network node of claim 21 wherein the radio network node is a next generation Node B in fifth generation system.
